(19) United States
(12) Patent Application Publication
(10) Pub. No.: US 2026/0169280 A1
(43) Pub. Date: Jun. 18, 2026

(54) VARIABLE OPTICAL ELEMENT BY TRANSLATION OF TWO CLOSE PLATES AND DESIGN METHOD THEREOF

(71) Applicant: Korea Electronics Technology Institute, Seongnam-si (KR)

(72) Inventors: Ji Soo HONG, Seoul (KR); Sung Hee HONG, Seoul (KR); Young Min KIM, Seoul (KR); Jin Soo JEONG, Seoul (KR); Yong Hwa KIM, Seoul (KR); Byoung Hyo LEE, Seoul (KR); Hyeon Chan OH, Seoul (KR)

(73) Assignee: Korea Electronics Technology Institute, Seongnam-si (KR)

(21) Appl. No.: 19/004,915

(22) Filed: Dec. 30, 2024

(30) Foreign Application Priority Data
Dec. 16, 2024 (KR) 10-2024-0186684

(51) Int. Cl. G02B 26/06; G02B 27/00

(52) U.S. Cl. CPC G02B 26/06; G02B 27/0012

(57) ABSTRACT

Provided are a variable optical element through translation of two close phase plates and a design method thereof. According to embodiments, in addition to a variable focus lens, a variable optical element may be designed to have arbitrary variability without limitations on types and specifications by attaching two phase plates and then moving the phase plates in different directions. An optical instrument having more diverse and more special optical characteristics may be implemented by using the variable optical element designed as above, and various and special applications systems using the same may be implemented.

### CROSS-REFERENCE TO RELATED APPLICATION(S) AND CLAIM OF PRIORITY

This application is based on and claims priority under 35 U.S.C. § 119 to Korean Patent Application No. 10-2024-0186684, filed on Dec. 16, 2024, in the Korean Intellectual Property Office, the disclosure of which is herein incorporated by reference in its entirety.

### BACKGROUND

### Field

The disclosure relates to a variable optical element, and more particularly, to a variable optical element with no real limitations on variability and no limitations on types and specifications, and a design method thereof.

### Description of Related Art

The Lohmann lens, which is one of methods of implementing variable focus lenses, may be implemented by attaching two cubic phase plates L₁, L₂ to each other with back surfaces facing each other as shown in FIG. 1, and then translating them in different directions.

In this case, the complex amplitudes of the cubic phase plates L₁, L₂ may be expressed as follows:

$${L}_{1} = exp [ jg ( x ) ] , {L}_{2} = exp [ jh ( x ) ]$$

In this case, g(x) and h(x) are expressed as follows:

$$g ( x ) = {c}_{0} {x}^{3} , h ( x ) = - {c}_{0} {x}^{3}$$

The total complex amplitude that is obtained when the two cubic phase plates are attached and are translated in the opposite direction by Δ may be expressed as follows:

$$T = exp [ jg ( x + Δ ) ] \times exp [ jh ( x - Δ ) ] = exp [ j \{ g ( x + Δ ) + h ( x - Δ ) \} ]$$

A phase of the total complex amplitude may be calculated as follows:

$$g ( x + Δ ) + h ( x - Δ ) = {{c}_{0} ( x + Δ )}^{3} - {{c}_{0} ( x - Δ )}^{3} = 6 {c}_{0} Δ {x}^{2} + 2 {c}_{0} {Δ}^{2}$$

In this case, a complex amplitude of a lens that has a focal distance of f and a wave number of k is as follows:

$$exp ( - \frac{j k {x}^{2}}{2 f} )$$

When the constant term of the phase (constant phase term) is disregarded and a translation amount Δ is determined as follows, a variable focus lens that has a variable focal distance according to a change in Δ may be implemented.

$$Δ = - \frac{k}{12 {c}_{0} f}$$

In particular, a ratio of a change in the focal distance to a change in Δ may be adjusted according to how c₀ is determined, and it is possible to implement the variable focus lens to vary the focal distance by a large margin even in response to a small change in Δ.

However, the Lohmann lens is only applicable to variable focus lenses, and there is a need for development of optical element design technologies applicable to an arbitrary variable optical member.

### SUMMARY

The disclosure has been developed in order to solve the above-described problems, and an object of the disclosure is to provide a method of designing a variable optical element to have arbitrary variability by attaching two phase plates and moving them in different directions, in addition to a variable focus lens, and a variable optical member designed by the same.

To achieve the above-described object, a variable optical element according to an embodiment of the disclosure may include: a first phase plate having a first optical surface formed on a front surface thereof; a second phase plate having a second optical surface formed on a front surface thereof, and having a rear surface in close contact with a rear surface of the first phase plate to be movable; and a controller configured to control movement of at least one of the first phase plate and the second phase plate with the first plate phase and the second plate phase being in close contact with each other, and the first phase plate and the second phase plate may function as variable optical elements while being in close contact with each other, the controller may vary optical characteristics of the variable optical element through movement of at least one of the first phase plate and the second phase plate, and the first optical surface and the second optical surface may be designable according to a type of the variable optical element.

The variable optical element may have a phase of the variable optical element at each position modulated by movement of at least one of the first phase plate and the second phase plate, such that the optical characteristics are variable.

The movement may be a translational movement in a first direction or a second direction which is opposite to the first direction.

A phase of the first optical plate may be expressed by a multiple-order function g(x, Δ) on a position x and a movement amount Δ, a phase of the second optical plate may be expressed by a multiple-order function h(x, Δ) on the position x and the movement amount Δ, a phase of the variable optical element may be expressed by a multiple-order function t(x, Δ) on the position x and the movement amount Δ, and wherein coefficients of some terms in the Taylor series of g(x, Δ) and coefficients of some terms in the Taylor series of h(x, Δ) may be determined by coefficients of corresponding terms of the Taylor series of t(x, Δ).

A coefficient of a term in which the order is 1 in the Taylor series of g(x, Δ), and a coefficient of a term in which the order is 1 in the Taylor series of h(x, Δ) may be arbitrarily determined under a condition where a sum of coefficients is the same as a coefficient of a term in which the order is 1 in the Taylor series of t(x, Δ).

A coefficient of a term in which the order is 2 in the Taylor series of g(x, Δ), and a coefficient of a term in which the order is 2 in the Taylor series of h(x, Δ) may be determined by coefficients the sum of which is coefficients of a term in which the order is 2 in the Taylor series of t(x, Δ).

A coefficient of a term in which the order is 3 in the Taylor series of g(x, Δ), and a coefficient of a term in which the order is 3 in the Taylor series of h(x, Δ) may be determined through optimization using coefficients of a term in which the order is 3 in the Taylor series of t(x, Δ).

According to the disclosure, the variable optical element may further include a third phase plat which has a third optical surface formed on a front surface thereof and is not moved by the controller, and a phase of the third optical plate may be the phase g(x) of the first optical plate and the phase h(x) of the second optical plate subtracted from the phase t(x) of the variable optical element when the order of Δ is 0.

If the variable optical element is a lens, the variable optical characteristics may be a focal distance, if the variable optical element is a prism, the variable optical characteristics may be a slope, if the variable optical element is a cylinder lens, the variable optical characteristics may be a focal distance according to a two-dimensional position (x,y), or if the variable optical element is an aberration correction lens, the variable optical characteristics may be coefficients of a Zernike polynomial.

According to another aspect of the disclosure, there is provided a variable optical element including: a step of modulating light entering the variable optical element, the variable optical element configured with a rear surface of a first phase plate having a first optical surface formed on a front surface thereof, and a rear surface of a second phase plate having a second optical surface formed on a front surface thereof being in close contact with each other to be movable; and a step of controlling at least one of the first phase plate and the second phase plate constituting the variable optical element in order to vary optical characteristics of the variable optical member, wherein the first optical surface and the second optical surface may be designable according to a type of the variable optical element.

According to still another aspect of the disclosure, there is provided a variable optical element design method including: a step of determining a phase of a variable optical element, the variable optical element configured with a rear surface of a first phase plate having a first optical surface formed on a front surface thereof, and a rear surface of a second phase plate having a second optical surface formed on a front surface thereof being in close contact with each other to be movable; and a step of determining a phase of the first phase plate and a phase of the second phase plate, based on the determined phase of the variable optical element.

According to embodiments of the disclosure as described above, in addition to a variable focus lens, the variable optical element may be designed to have arbitrary variability without limitations on types and specifications by attaching two phase plates and then moving the phase plates in different directions.

In addition, according to embodiments of the disclosure, an optical instrument having more diverse and more special optical characteristics may be implemented by using the variable optical element designed by the above-described method, and various and special applications systems using the same may be implemented.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a method for implementing a variable focus lens by using the Lohmann lens;

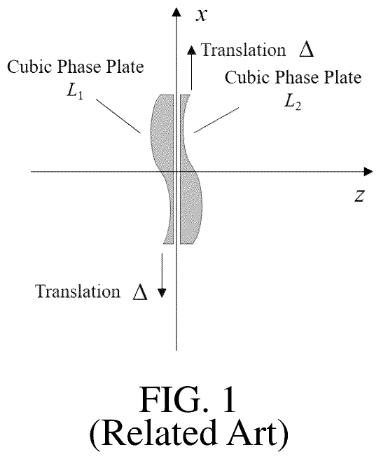

FIG. 2 is a view illustrating implementation of an arbitrary variable optical element by translation of two phase plates;

FIG. 3 is a view illustrating a method for implementing a translation-based variable optical element which separately implements a term in which the order of Δ is 0; and

FIG. 4 is a view illustrating a configuration of a variable optical element according to an embodiment of the disclosure.

### DETAILED DESCRIPTION

Hereinafter, the disclosure will be described in more detail with reference to the accompanying drawings.

Embodiments of the disclosure propose a variable optical element with no real limitations on variability and a design method thereof. The disclosure relates to a technology that enables a variable optical element to have arbitrary variability through translation of two close phase plates.

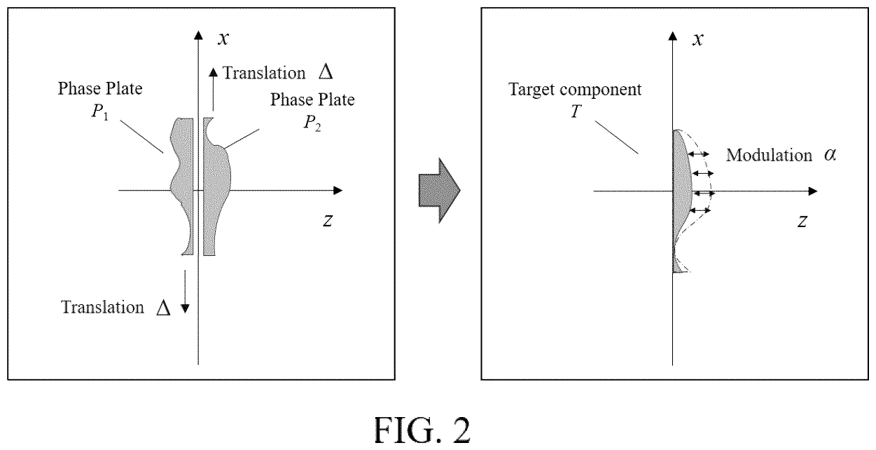

FIG. 2 illustrate a concept of implementing an arbitrary variable optical element T that is modulated by one modulation parameter α, by translating two phase plates P₁, P₂ in different directions (left view) by Δ according to an embodiment of the disclosure. In this case, complex amplitudes of the two phase plates P₁, P₂ may be written as follows:

$${P}_{1} = exp [ jg ( x ) ] , {P}_{2} = exp [ jh ( x ) ]$$

In addition, the complex amplitude of the variable optical element T that is modulated by one modulation parameter α may be written as follows:

$$T = exp [ jt ( x , α ) ]$$

The variable optical element according to an embodiment of the disclosure may be modulated by translating the two phase plates P₁, P₂ in different directions (an amount of movement: Δ), and may be written as follows:

$$T = exp [ jg ( x + Δ ) ] \times exp [ jh ( x - Δ ) ]$$

In this case, the modulation parameter α of the variable optical element T is connected with the translation amount Δ by mapping μ as follows:

$$μ : Δ \to α$$

In this case, mapping may have any form, but it is advantageous that mapping is given in the form of a gamma function so as to respond to the case where the required resolution of the modulation parameter is not uniform, and may use the following equation, including Δ₀ to give an offset to allow a scaling factor β and the translation amount Δ to be close to 0:

$$α = β \cdot {( Δ )}^{γ} + {Δ}_{0}$$

Instead of T(x, α), T(x, Δ) may be used due to such mapping.

Meanwhile, the following notations are promised for Tayler expansion around x=0, Δ=0 with respect to g(x), h(x), T(x, Δ) as follows:

$${g}^{( n )} = \frac{{d}^{n} g ( x )}{d {x}^{n}} {\vert}_{x = 0} , {h}^{( n )} = \frac{{d}^{n} h ( x )}{d {x}^{n}} {\vert}_{x = 0}$$

$${t}^{( Δ = n )} = \frac{{\partial }^{n} t}{\partial {Δ}^{n}} {\vert}_{Δ = 0}$$

$${t}^{( x = m ; Δ = n )} = \frac{{\partial }^{m}}{\partial {x}^{m}} ( \frac{{\partial }^{n} t}{\partial {Δ}^{n}} {\vert}_{Δ = 0} ) {\vert}_{x = 0}$$

g(x) and h(x) may be written as follows through the Taylor expansion around x=0.

$$g ( x ) = {\sum }_{n = 0}^{∞} \frac{{g}^{( n )}}{n !} {x}^{n} , h ( x ) = {\sum }_{n = 0}^{∞} \frac{{h}^{( n )}}{n !} {x}^{n}$$

In this case, g(x) and h(x) are as follows when they are translated by −Δ and +Δ, respectively:

$$g ( x + Δ ) = {\sum }_{n = 0}^{∞} \frac{{g}^{( n )}}{n !} {( x + Δ )}^{n} = {\sum }_{n = 0}^{∞} \frac{{g}^{( n )}}{n !} {\sum }_{r = 0}^{n} {}_{n} {C}_{r} {x}^{n - r} {Δ}^{r}$$

$$h ( x - Δ ) = {\sum }_{n = 0}^{∞} \frac{{h}^{( n )}}{n !} {( x - Δ )}^{n} = {\sum }_{n = 0}^{∞} \frac{{h}^{( n )}}{n !} {\sum }_{r = 0}^{n} {}_{n} {C}_{r} {{x}^{n - r} ( - 1 )}^{r} {Δ}^{r}$$

Accordingly, the phase of the complex amplitude that is obtained by attaching the two phase plates P₁, P₂ and then translating the phase plates in opposite directions by Δ is as follows:

$$g ( x + Δ ) + h ( x - Δ ) = {\sum }_{n = 0}^{∞} \frac{1}{n !} {\sum }_{r = 0}^{n} {}_{n} {C}_{r} {x}^{n - r} \{ {g}^{( n )} + {{h}^{( n )} ( - 1 )}^{r} \} {Δ}^{r}$$

The above equation may be re-written as follows by arranging by the order of Δ:

$$g ( x + Δ ) + h ( x - Δ ) = {\sum }_{k = 0}^{∞} {\sum }_{n = k}^{∞} \frac{{}_{n} {C}_{k}}{n !} {x}^{n - k} \{ {g}^{( n )} + {{h}^{( n )} ( - 1 )}^{k} \} {Δ}^{k}$$

Meanwhile, the phase t(x, Δ) of the variable optical element T may be expressed as follows by the Taylor expansion around Δ=0:

$$t ( x , Δ ) = {\sum }_{n = 0}^{∞} \frac{{t}^{( Δ = n )}}{n !} {Δ}^{n}$$

Accordingly, if the coefficient

$$\frac{{t}^{( Δ = k )}}{k !}$$

when the order n of Δ is k is consistent with the coefficient when the order n of A in the Taylor expansion equation of g(x+Δ)+h(x−Δ) is k with respect to all k values, the target modulation of the variable optical element T may be completely reproduced by the translation of the two phase plates P₁, P₂. Accordingly, it is necessary to design to establish the following equation for all k values:

$$\frac{{t}^{( Δ = k )}}{k !} = {\sum }_{n = k}^{∞} \frac{{}_{n} {C}_{k}}{n !} {x}^{n - k} \{ {g}^{( n )} + {{h}^{( n )} ( - 1 )}^{k} \}$$

If n−k=r, the right term of the above equation may be rewritten as follows:

$${\sum }_{r = 0}^{∞} \frac{{}_{r + k} {C}_{k}}{( r + k ) !} \{ {g}^{( r + k )} + {{h}^{( r + k )} ( - 1 )}^{k} \} {x}^{r}$$

The left term may be written as follows through the Taylor expansion around x=0:

$$\frac{{t}^{( Δ = k )}}{k !} = {\sum }_{r = 0}^{∞} \frac{{t}^{( x = r ; Δ = k )}}{k ! r !} {x}^{r}$$

Accordingly, the above-described condition may be re-written to establish the following equation with respect to all k values:

$${\sum }_{r = 0}^{∞} \frac{{t}^{( x = r ; Δ = k )}}{k ! r !} {x}^{r} = {\sum }_{r = 0}^{∞} \frac{{}_{r + k} {C}_{k}}{( r + k ) !} \{ {g}^{( r + k )} + {{h}^{( r + k )} ( - 1 )}^{k} \} {x}^{r}$$

Since the coefficients of all degrees of x have only to be the same, the above equation may be re-written to establish the following equation with respect to all k and r values.

$$\frac{{t}^{( x = r ; Δ = k )}}{k ! r !} = \frac{{}_{r + k} {C}_{k}}{( r + k ) !} \{ {g}^{( r + k )} + {{h}^{( r + k )} ( - 1 )}^{k} \}$$

This may be written in the form of a matrix as follows:

$$[ \begin{matrix}\frac{{}_{0} {C}_{0}}{0 !} {g}^{( 0 )} & \frac{{}_{1} {C}_{0}}{1 !} {g}^{( 1 )} & \frac{{}_{2} {C}_{0}}{2 !} {g}^{( 2 )} & ⋯ \\ \frac{{}_{1} {C}_{1}}{1 !} {g}^{( 1 )} & \frac{{}_{2} {C}_{1}}{2 !} {g}^{( 2 )} & \frac{{}_{3} {C}_{1}}{3 !} {g}^{( 3 )} & ⋯ \\ \frac{{}_{2} {C}_{2}}{2 !} {g}^{( 2 )} & \frac{{}_{3} {C}_{2}}{3 !} {g}^{( 3 )} & \frac{{}_{4} {C}_{2}}{4 !} {g}^{( 4 )} & ⋯ \\ ⋮ & ⋮ & ⋮ & ⋱\end{matrix} ] + [ \begin{matrix}\frac{{}_{0} {C}_{0}}{0 !} {h}^{( 0 )} & \frac{{}_{1} {C}_{0}}{1 !} {h}^{( 1 )} & \frac{{}_{2} {C}_{0}}{2 !} {h}^{( 2 )} & ⋯ \\ - \frac{{}_{1} {C}_{1}}{1 !} {h}^{( 1 )} & - \frac{{}_{2} {C}_{1}}{2 !} {h}^{( 2 )} & - \frac{{}_{3} {C}_{1}}{3 !} {h}^{( 3 )} & ⋯ \\ \frac{{}_{2} {C}_{2}}{2 !} {h}^{( 2 )} & \frac{{}_{3} {C}_{2}}{3 !} {h}^{( 3 )} & \frac{{}_{4} {C}_{2}}{4 !} {h}^{( 4 )} & ⋯ \\ ⋮ & ⋮ & ⋮ & ⋱\end{matrix} ] = [ \begin{matrix}\frac{1}{0 ! 0 !} {t}^{( x = 0 ; Δ = 0 )} & \frac{1}{0 ! 1 !} {t}^{( x = 1 ; Δ = 0 )} & \frac{1}{0 ! 2 !} {t}^{( x = 2 ; Δ = 0 )} & ⋯ \\ \frac{1}{1 ! 0 !} {t}^{( x = 0 ; Δ = 1 )} & \frac{1}{1 ! 1 !} {t}^{( x = 1 ; Δ = 1 )} & \frac{1}{1 ! 2 !} {t}^{( x = 2 ; Δ = 1 )} & ⋯ \\ \frac{1}{2 ! 0 !} {t}^{( x = 0 ; Δ = 2 )} & \frac{1}{2 ! 1 !} {t}^{( x = 1 ; Δ = 2 )} & \frac{1}{2 ! 2 !} {t}^{( x = 2 ; Δ = 2 )} & ⋯ \\ ⋮ & ⋮ & ⋮ & ⋱\end{matrix} ]$$

In this case, if T−t^{(Δ=0)} excluding the term that is not modulated in the variable optical element T, that is, the term in which the order of Δ is 0, is set as a target, and g(x) and h(x) are found, the above matrix may be changed to the following condition excluding the first row in the above matrix:

$$[ \begin{matrix}\frac{{}_{1} {C}_{1}}{1 !} {g}^{( 1 )} & \frac{{}_{2} {C}_{1}}{2 !} {g}^{( 2 )} & \frac{{}_{3} {C}_{1}}{3 !} {g}^{( 3 )} & ⋯ \\ \frac{{}_{2} {C}_{2}}{2 !} {g}^{( 2 )} & \frac{{}_{3} {C}_{2}}{3 !} {g}^{( 3 )} & \frac{{}_{4} {C}_{2}}{4 !} {g}^{( 4 )} & ⋯ \\ \frac{{}_{3} {C}_{3}}{3 !} {g}^{( 3 )} & \frac{{}_{4} {C}_{3}}{4 !} {g}^{( 4 )} & \frac{{}_{5} {C}_{3}}{5 !} {g}^{( 5 )} & ⋯ \\ ⋮ & ⋮ & ⋮ & ⋱\end{matrix} ] + [ \begin{matrix}- \frac{{}_{1} {C}_{1}}{1 !} {h}^{( 1 )} & - \frac{{}_{2} {C}_{1}}{2 !} {h}^{( 2 )} & - \frac{{}_{3} {C}_{1}}{3 !} {h}^{( 3 )} & ⋯ \\ \frac{{}_{2} {C}_{2}}{2 !} {h}^{( 2 )} & \frac{{}_{3} {C}_{2}}{3 !} {h}^{( 3 )} & \frac{{}_{4} {C}_{2}}{4 !} {h}^{( 4 )} & ⋯ \\ - \frac{{}_{3} {C}_{3}}{3 !} {h}^{( 3 )} & - \frac{{}_{4} {C}_{3}}{4 !} {h}^{( 4 )} & - \frac{{}_{5} {C}_{3}}{5 !} {h}^{( 5 )} & ⋯ \\ ⋮ & ⋮ & ⋮ & ⋱\end{matrix} ] = [ \begin{matrix}\frac{1}{1 ! 0 !} {t}^{( x = 0 ; Δ = 1 )} & \frac{1}{1 ! 1 !} {t}^{( x = 1 ; Δ = 1 )} & \frac{1}{1 ! 2 !} {t}^{( x = 2 ; Δ = 1 )} & ⋯ \\ \frac{1}{2 ! 0 !} {t}^{( x = 0 ; Δ = 2 )} & \frac{1}{2 ! 1 !} {t}^{( x = 1 ; Δ = 2 )} & \frac{1}{2 ! 2 !} {t}^{( x = 2 ; Δ = 2 )} & ⋯ \\ \frac{1}{3 ! 0 !} {t}^{( x = 0 ; Δ = 3 )} & \frac{1}{3 ! 1 !} {t}^{( x = 1 ; Δ = 3 )} & \frac{1}{3 ! 2 !} {t}^{( x = 2 ; Δ = 3 )} & ⋯ \\ ⋮ & ⋮ & ⋮ & ⋱\end{matrix} ]$$

In this case, the rank of the matrix of the variable optical element which is the target matrix of the right side is higher than the rank of the matrix of the phase plate P₁, P₂ to be designed, the target matrix may be optimized for a lower order of g(x) and h(x). For example, if the phase plates are designed considering the 3^{rd} degree of g(x) and h(x), g(x) and h(x) satisfying components of set 1, set 2, set 3 of the target matrix may be optimized.

$$[ \begin{matrix}\frac{{}_{1} {C}_{1}}{1 !} {g}^{( 1 )} & \frac{{}_{2} {C}_{1}}{2 !} {g}^{( 2 )} & \frac{{}_{3} {C}_{1}}{3 !} {g}^{( 3 )} & \frac{{}_{4} {C}_{1}}{4 !} {g}^{( 4 )} \\ \frac{{}_{2} {C}_{2}}{2 !} {g}^{( 2 )} & \frac{{}_{3} {C}_{2}}{3 !} {g}^{( 3 )} & \frac{{}_{4} {C}_{2}}{4 !} {g}^{( 4 )} & \frac{{}_{5} {C}_{2}}{5 !} {g}^{( 5 )} \\ \frac{{}_{3} {C}_{3}}{3 !} {g}^{( 3 )} & \frac{{}_{4} {C}_{3}}{4 !} {g}^{( 4 )} & \frac{{}_{5} {C}_{3}}{5 !} {g}^{( 5 )} & \frac{{}_{6} {C}_{3}}{6 !} {g}^{( 6 )} \\ \frac{{}_{4} {C}_{4}}{4 !} {g}^{( 4 )} & \frac{{}_{5} {C}_{4}}{5 !} {g}^{( 5 )} & \frac{{}_{6} {C}_{4}}{6 !} {g}^{( 6 )} & \frac{{}_{7} {C}_{4}}{7 !} {g}^{( 7 )}\end{matrix} ] + [ \begin{matrix}- \frac{{}_{1} {C}_{1}}{1 !} {h}^{( 1 )} & - \frac{{}_{2} {C}_{1}}{2 !} {h}^{( 2 )} & - \frac{{}_{3} {C}_{1}}{3 !} {h}^{( 3 )} & - \frac{{}_{4} {C}_{1}}{4 !} {h}^{( 4 )} \\ \frac{{}_{2} {C}_{2}}{2 !} {h}^{( 2 )} & \frac{{}_{3} {C}_{2}}{3 !} {h}^{( 3 )} & \frac{{}_{4} {C}_{2}}{4 !} {h}^{( 4 )} & \frac{{}_{5} {C}_{2}}{5 !} {h}^{( 5 )} \\ - \frac{{}_{3} {C}_{3}}{3 !} {h}^{( 3 )} & - \frac{{}_{4} {C}_{3}}{4 !} {h}^{( 4 )} & - \frac{{}_{5} {C}_{3}}{5 !} {h}^{( 5 )} & - \frac{{}_{6} {C}_{3}}{6 !} {h}^{( 6 )} \\ \frac{{}_{4} {C}_{4}}{4 !} {h}^{( 4 )} & \frac{{}_{5} {C}_{4}}{5 !} {h}^{( 5 )} & \frac{{}_{6} {C}_{4}}{6 !} {h}^{( 6 )} & \frac{{}_{7} {C}_{4}}{7 !} {h}^{( 7 )}\end{matrix} ] \begin{matrix}Set 1 \\ Set 2 \\ = \\ Set 3\end{matrix} [ \begin{matrix}\frac{1}{1 ! 0 !} {t}^{( x = 0 ; Δ = 1 )} & \frac{1}{1 ! 1 !} {t}^{( x = 1 ; Δ = 1 )} & \frac{1}{1 ! 2 !} {t}^{( x = 2 ; Δ = 1 )} & \frac{1}{1 ! 3 !} {t}^{( x = 3 ; Δ = 1 )} \\ \frac{1}{2 ! 0 !} {t}^{( x = 0 ; Δ = 2 )} & \frac{1}{2 ! 1 !} {t}^{( x = 1 ; Δ = 2 )} & \frac{1}{2 ! 2 !} {t}^{( x = 2 ; Δ = 2 )} & \frac{1}{2 ! 3 !} {t}^{( x = 3 ; Δ = 2 )} \\ \frac{1}{3 ! 0 !} {t}^{( x = 0 ; Δ = 3 )} & \frac{1}{3 ! 1 !} {t}^{( x = 1 ; Δ = 3 )} & \frac{1}{3 ! 2 !} {t}^{( x = 2 ; Δ = 3 )} & \frac{1}{3 ! 3 !} {t}^{( x = 3 ; Δ = 3 )} \\ \frac{1}{4 ! 0 !} {t}^{( x = 0 ; Δ = 4 )} & \frac{1}{4 ! 1 !} {t}^{( x = 1 ; Δ = 4 )} & \frac{1}{4 ! 2 !} {t}^{( x = 2 ; Δ = 4 )} & \frac{1}{4 ! 3 !} {t}^{( x = 3 ; Δ = 4 )}\end{matrix} ]$$

For the target T−t^{(Δ=0)}, g⁽¹⁾ and h⁽¹⁾ have only to be appropriately determined to satisfy the following equation. Since variables to be obtained are two variables (g⁽¹⁾ and h⁽¹⁾) but there is one equation, there are many solutions of the variables. That is, there are many combinations of g⁽¹⁾ and h⁽¹⁾ that make g⁽¹⁾-h⁽¹⁾ equal t^{(x=0, Δ=1)}, and hence, g⁽¹⁾ and h⁽¹⁾ have only to be determined according to a type and specifications of the target variable optical element T.

$${t}^{( x = 0 , Δ = 1 )} = \{ {g}^{( 1 )} - {h}^{( 1 )} \}$$

g⁽²⁾ and h⁽²⁾ are determined by the following equation. Since there are two variables (g⁽²⁾ and h⁽²⁾) to obtain and there are two equations, there is only one solution to the variable. Accordingly, g⁽²⁾ and h⁽²⁾ have only to be determined as the solutions of the following equations.

$${g}^{( 2 )} = \frac{{t}^{( x = 1 ; Δ = 1 )} + {t}^{( x = 0 ; Δ = 2 )}}{2} , {h}^{( 2 )} = \frac{{t}^{( x = 0 ; Δ = 2 )} - {t}^{( x = 1 ; Δ = 1 )}}{2}$$

From the 3^{rd} order of g(x) and h(x), the rank of the corresponding set in the target matrix is higher. Since there are three or more variables that should be obtained, but only two equations are given, the solution may not be determined through equation solving. In this case, the solution should be obtained through optimization. If G₃, H₃, S₃ corresponding to coefficients of g⁽³⁾ and h⁽³⁾ which are 3^{rd} order, and corresponding sets of the target matrix are defined as follows:

$${G}_{3} = [ \begin{matrix}\frac{{}_{3} {C}_{1}}{3 !} \\ \frac{{}_{3} {C}_{2}}{3 !} \\ \frac{{}_{3} {C}_{3}}{3 !}\end{matrix} ] , {H}_{3} = [ \begin{matrix}- \frac{{}_{3} {C}_{1}}{3 !} \\ \frac{{}_{3} {C}_{2}}{3 !} \\ - \frac{{}_{3} {C}_{3}}{3 !}\end{matrix} ] , {S}_{3} = [ \begin{matrix}\frac{1}{1 ! 2 !} {t}^{( x = 2 , Δ = 1 )} \\ \frac{1}{2 ! 1 !} {t}^{( x = 1 , Δ = 2 )} \\ \frac{1}{3 ! 0 !} {t}^{( x = 0 , Δ = 3 )}\end{matrix} ] ,$$

the optimal solutions of g⁽³⁾ and h⁽³⁾ may be obtained through the following optimization process. That is, g⁽³⁾ and h⁽³⁾ that have a minimum value of the absolute value of the following determinant may be determined among g⁽³⁾ and h⁽³⁾ which satisfy the above determinant.

$$\{ {\hat{g}}^{( 3 )} , {\hat{h}}^{( 3 )} \} = arg {min}_{\{ {g}^{( 3 )} , {h}^{( 3 )} \}} ‖ {G}_{3} {g}^{( 3 )} + {H}_{3} {h}^{( 3 )} - {S}_{3} ‖$$

Accordingly, unlike when the rank of the set of the target matrix is less than or equal to 2, when the rank is greater than or equal to 3, there may be an error caused by optimization.

The design method described above may be applied to higher orders, but as the design order of g(x) and h(x) increases, the maximum rank of the set of the target matrix to be covered may increase, so that the errors caused by optimization increase and it is desirable to limit the order to about the third order when designing.

Accordingly, g₀(x) and h₀(x) which can implement T−t^{(Δ=0)} excluding the term in which the order of Δ is 0 may be determined as follows:

$${g}_{0} ( x ) = {g}^{( 1 )} x + \frac{{g}^{( 2 )}}{2} {x}^{2} + \frac{{\hat{g}}^{( 3 )}}{3 !} {x}^{3} ,$$

$${h}_{0} ( x ) = {h}^{( 1 )} x + \frac{{h}^{( 2 )}}{2} {x}^{2} + \frac{{\hat{h}}^{( 3 )}}{3 !} {x}^{3}$$

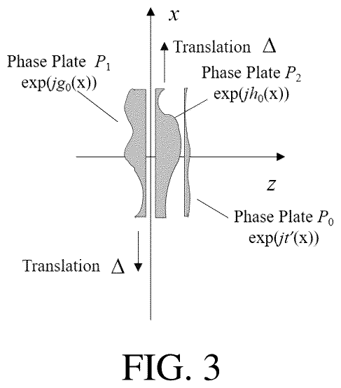

Meanwhile, t^{(Δ=0)} which is not considered in g₀(x) and h₀(x) may be reflected by adding a separate fixed phase plate P₀ as shown in FIG. 3, and, if t′ excluding the term that is influenced by coefficients from the first order to the third order in g(x) and h(x) is defined as follows:

$${t}^{′} = {t}^{( Δ = 0 )} - \{ [ {g}^{( 1 )} + {h}^{( 1 )} ] x + \frac{{g}^{( 2 )} + {h}^{( 2 )}}{2} {x}^{2} + \frac{{g}^{( 3 )} + {h}^{( 3 )}}{3} {x}^{3} \} ,$$

the total T may be implemented by reflecting t′ by additionally making and attaching the fixed phase plate P₃. That is, as shown in FIG. 3, the two phase plates P₁, P₂ are designed and attached to allow exp[jg₀(x)] and exp[jh₀(x)] to satisfy the condition proposed above, and then, are translated in different directions by Δ, and, by additionally attaching the fixed phase plate P₀ having the complex amplitude of exp[jt′(x)], the variable optical element T which can be modulated for the modulation parameter α may be implemented.

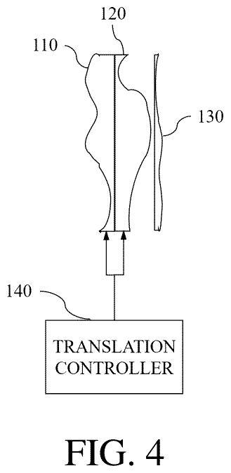

FIG. 4 is a view illustrating a configuration of a variable optical element according to an embodiment of the disclosure. The variable optical element according to an embodiment of the disclosure may be designed according to the above-described method, and may include an optical plate #1 110, an optical plate #2 120, an optical plate #0 130 and a translation controller 140.

The optical plate #1 110 may be the above-described optical plate P₁, and may have an optical surface #1 formed on the front surface thereof, and the optical plate #2 120 may be the above-described optical plate P₂ and may have an optical surface #2 formed on the front surface thereof, and the optical plate #1 110 and the optical plate #2 120 may be translated in the opposite directions with rear surfaces being in close contact with each other.

The phase of the optical plate #1 110 may be expressed by a multiple-order function g(x, Δ) on a position x and a translation amount Δ, and the phase of the optical plate #2 120 may be expressed by a multiple-order function h(x, Δ) on the position x and the translation amount Δ.

g(x, Δ) and h(x Δ) may be designed according to a phase of a targeted variable optical element T. Specifically, when the phase of the variable optical element T is expressed by the multiple-order function t(x Δ) on the position x and the movement A, coefficients of some terms in the Tayler series of g(x, Δ) and coefficients of some terms in the Tayler series of h(x, Δ) may be determined by coefficients of corresponding terms of the Tayler series of t(x, Δ). If the term in the Tayler series of the phase is limited to the 3^{rd} order as in the above-described design method,
1) the coefficient of the term in which the order is 1 in the Taylor series of g(x, Δ), and the coefficient of the term in which the order is 1 in the Taylor series of h(x, Δ) may be arbitrarily determined under the condition where the sum of coefficients is the same as the coefficient of the term in which the order is 1 in the Taylor series of t(x, Δ),
2) the coefficient of the term in which the order is 2 in the Taylor series of g(x, Δ), and the coefficient of the term in which the order is 2 in the Taylor series of h(x, Δ) may be determined by coefficients the sum of which is coefficients of the term in which the order is 2 in the Taylor series of t(x, Δ), and
3) the coefficient of the term in which the order is 3 in the Taylor series of g(x, Δ), and the coefficient of the term in which the order is 3 in the Taylor series of h(x, Δ) may be determined through optimization using coefficients the sum of which is coefficients of the term in which the order is 3 in the Taylor series of t(x, Δ).

The optical plate #0 130 may be the above-described optical plate P₀, and may have an optical surface #3 formed on the front surface thereof, and may be fixed without being moved by the translation controller 140. The phase t′ (x) of the optical plate #0 130 may be the phase g(x; Δ=0) of the optical plate #1 110 and the phase h(x; Δ=0) of the optical plate #2 120 subtracted from the phase t(x; Δ=0) of the variable optical element T which is targeted when the order of Δ is 0.

The variable optical element configured by the optical plates 110, 120, 130 may modulate incident light and emit the light.

The translation controller 140 is configured to control movements of the optical plate #1 110 and the optical plate #2 120, and may translate the optical plate #1 110 and the optical plate #2 120 in the opposite directions. In this case, a control parameter may be a translation amount Δ, and optical characteristics of the ultimately targeted variable optical element T may be changed by adjusting the control parameter.

1) If the variable optical element T is a lens, the variable optical characteristics may be a focal distance of the lens, 2) if the variable optical element T is a prism, the variable optical characteristics may be a slope of the prism, 3) if the variable optical element T is a cylinder lens, the variable optical characteristics may be a focal distance according to a two-dimensional position (x,y) of the cylinder lens, or 4) if the variable optical element T is an aberration correction lens, the variable optical characteristics may be coefficients of a Zernike polynomial of the aberration correction lens.

Up to now, the variable optical element achieved through translation of the two close phase plates, and the design method thereof have been described in detail with reference to preferred embodiments.

In the above-described embodiments, in addition to a variable focus lens, the variable optical element may be designed to have arbitrary variability without limitations on types and specifications by attaching two phase plates and then moving the phase plates in different directions.

When the variable optical element designed by the above-described method is used, an optical instrument having more diverse and more special optical characteristics may be implemented, and various and special applications systems using the same may be implemented.

In the above-described embodiments, it is assumed that the two phase plates are translated, but one of them may be fixed and the other one may be translated so that a phase of each point of the variable optical element may be modulated and variable characteristics may be changed.

The design method described above has been discussed on an one-dimensional optical element, but may be expandable to a two-dimensional optical element, and this case may be included in the scope of the disclosure.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A variable optical element comprising:
a first phase plate having a first optical surface formed on a front surface thereof;
a second phase plate having a second optical surface formed on a front surface thereof, and having a rear surface in close contact with a rear surface of the first phase plate to be movable; and
a controller configured to control movement of at least one of the first phase plate and the second phase plate with the first plate phase and the second plate phase being in close contact with each other,
wherein the first phase plate and the second phase plate function as variable optical elements while being in close contact with each other,
wherein the controller is configured to vary optical characteristics of the variable optical element through movement of at least one of the first phase plate and the second phase plate,
wherein the first optical surface and the second optical surface are designable according to a type of the variable optical element.

2. The variable optical element of claim 1, wherein the variable optical element has a phase of the variable optical element at each position modulated by movement of at least one of the first phase plate and the second phase plate, such that the optical characteristics are variable.

3. The variable optical element of claim 1, wherein the movement is a translational movement in a first direction or a second direction which is opposite to the first direction.

4. The variable optical element of claim 1, wherein a phase of the first optical plate is expressed by a multiple-order function g(x, Δ) on a position x and a movement amount Δ,
wherein a phase of the second optical plate is expressed by a multiple-order function h(x, Δ) on the position x and the movement amount Δ,
wherein a phase of the variable optical element is expressed by a multiple-order function t(x, Δ) on the position x and the movement amount Δ, and
wherein coefficients of some terms in the Taylor series of g(x, Δ) and coefficients of some terms in the Taylor series of h(x, Δ) are determined by coefficients of corresponding terms of the Taylor series of t(x, Δ).

5. The variable optical element of claim 4, wherein a coefficient of a term in which the order is 1 in the Taylor series of g(x, Δ), and a coefficient of a term in which the order is 1 in the Taylor series of h(x, Δ) are arbitrarily determined under a condition where a sum of coefficients is the same as a coefficient of a term in which the order is 1 in the Taylor series of t(x, Δ).

6. The variable optical element of claim 4, wherein a coefficient of a term in which the order is 2 in the Taylor series of g(x, Δ), and a coefficient of a term in which the order is 2 in the Taylor series of h(x, Δ) are determined by coefficients the sum of which is coefficients of a term in which the order is 2 in the Taylor series of t(x, Δ).

7. The variable optical element of claim 4, wherein a coefficient of a term in which the order is 3 in the Taylor series of g(x, Δ), and a coefficient of a term in which the order is 3 in the Taylor series of h(x, Δ) are determined through optimization using coefficients of a term in which the order is 3 in the Taylor series of t(x, Δ).

8. The variable optical element of claim 4, further comprising a third phase plat which has a third optical surface formed on a front surface thereof and is not moved by the controller,
wherein a phase of the third optical plate is the phase g(x) of the first optical plate and the phase h(x) of the second optical plate subtracted from the phase t(x) of the variable optical element when the order of Δ is 0.

9. The variable optical element of claim 1, wherein, if the variable optical element is a lens, the variable optical characteristics are a focal distance, if the variable optical element is a prism, the variable optical characteristics are a slope, if the variable optical element is a cylinder lens, the variable optical characteristics are a focal distance according to a two-dimensional position (x,y), or if the variable optical element is an aberration correction lens, the variable optical characteristics are coefficients of a Zernike polynomial.

10. A variable optical element comprising:
a step of modulating light entering the variable optical element, the variable optical element configured with a rear surface of a first phase plate having a first optical surface formed on a front surface thereof, and a rear surface of a second phase plate having a second optical surface formed on a front surface thereof being in close contact with each other to be movable; and
a step of controlling at least one of the first phase plate and the second phase plate constituting the variable optical element in order to vary optical characteristics of the variable optical member,
wherein the first optical surface and the second optical surface are designable according to a type of the variable optical element.

11. A variable optical element design method comprising:
a step of determining a phase of a variable optical element, the variable optical element configured with a rear surface of a first phase plate having a first optical surface formed on a front surface thereof, and a rear surface of a second phase plate having a second optical surface formed on a front surface thereof being in close contact with each other to be movable; and
a step of determining a phase of the first phase plate and a phase of the second phase plate, based on the determined phase of the variable optical element.
